(19) United States
(12) Patent Application Publication
(10) Pub. No.: US 2012/0138784 A1
(43) Pub. Date: Jun. 7, 2012

(54) Method for in Vivo Measurement of Reverse Cholesterol Transport

(76) Inventors: Daniel J. Rader, Philadelphia, PA (US); Jeffrey T. Billheimer, West Chester, PA (US)

(21) Appl. No.: 13/350,207

(22) Filed: Jan. 13, 2012

Related U.S. Application Data
(63) Continuation-in-part of application No. PCT/US2010/042247, filed on Jul. 16, 2010.
(60) Provisional application No. 61/226,122, filed on Jul. 16, 2009.

(51) Int. Cl. H01J 49/26; G01T 1/00

(52) U.S. Cl. 250/282; 250/395

(57) ABSTRACT

Methods and compositions for the in vivo measurement of reverse cholesterol transport are provided.

This application is a continuation-in-part of PCT/US2010/042247, filed on Jul. 16, 2010, which claims priority under 35 U.S.C. §119(e) to U.S. Provisional Patent Application No. 61/226,122, filed on Jul. 16, 2009. The foregoing applications are incorporated by reference herein.

### FIELD OF THE INVENTION

The present invention relates to the measurement of reverse cholesterol transport.

### BACKGROUND OF THE INVENTION

Several publications and patent documents are cited throughout the specification in order to describe the state of the art to which this invention pertains. Each of these citations is incorporated by reference herein as though set forth in full.

Reverse cholesterol transport (RCT) was first introduced in 1968 to describe the process of how extrahepatic cholesterol is returned to the liver for elimination (Glomset, J. A. (1968) J. Lipid Res., 9:155-67). Its association with atherosclerosis involves cholesterol efflux from macrophages, foam cells that are laden with cholesterol and deposit within the arterial wall, to the liver for excretion (Cuchel et al. (2006) Circulation, 113:2548-55). RCT is a complex process involving multiple pathways and acceptor particles. A major area of interest in therapeutic approaches to atherosclerosis involves developing pharmacological agents to enhance RCT (Lewis et al. (2005) Cir. Res., 96:1221-32). Therapies currently under development focus on several targets of the RCT pathway including: upregulation of apolipoprotein A-I, high density lipoprotein cholesterol (HDL-C), adenosine triphosphate-binding cassette protein (ABC) A1 and ABCG1; inhibition of cholesteryl ester transfer protein; and synthetic agonists of the nuclear receptors liver X receptor and peroxisome proliferators-activated receptors (PPAR)-α, -δ, and -γ. Therefore, assessing the effects of therapeutic agents on RCT is critical.

A method to trace RCT specifically from macrophage to feces in mice has been developed. After intraperitoneal injection of macrophages labeled with ³H-cholesterol, the tracer can be detected in plasma, liver, bile, and feces (Zhang et al. (2003) Circulation, 108:661-3). This method has been used to demonstrate either enhancement or reduction of RCT in several mouse models for lipid metabolism and proves that methods that assess macrophage specific RCT may be more useful in dissecting the molecular regulation of RCT as it is relevant to atherogenesis (Zhang et al. (2005) J. Clin. Invest., 115:2870-4; Naik et al. (2006) Circulation, 113:90-7). Unfortunately this method has serious limitations to be used to assess RCT in humans and a more suitable approach must be found.

Currently, there is no available method to assess RCT in humans. Attempts to measure RCT in humans, such as the administration of tritiated water and quantification of bile and fecal sterol excretion, have only detected single steps of the RCT pathway and have failed to measure net “reverse cholesterol” flux from extrahepatic tissues to the liver or on fecal sterol excretion (Cuchel et al. (2006) Circulation, 113:2548-55).

### SUMMARY OF THE INVENTION

In accordance with one aspect of the instant invention, methods for measuring reverse cholesterol transport in a mammal are provided. In a specific embodiment, the methods comprise the steps of a) administering at least one composition comprising microparticulate cholesterol to a mammal, b) obtaining at least one biological sample from the mammal; and c) determining the amount of the cholesterol administered in step a) in the biological sample obtained in step b). A decrease in the administered cholesterol in the biological sample relative to that obtained from normal subject indicates decreased reverse cholesterol transport in the subject while an increase would indicate increased reverse cholesterol transport. In a particular embodiment, the cholesterol administered to the mammal is isotopically labeled.

In accordance with another aspect of the instant invention, methods for determining the ability of a test compound to modulate reverse cholesterol transport in a mammal are provided. In a particular embodiment, the methods comprise generating a first profile of a labeled cholesterol administered to a mammal in the above methods for measuring reverse cholesterol transport, and repeating the methods for measuring reverse cholesterol transport after administering a test compound to the mammal, thereby generating a second profile. Differences between the first and second profiles are indicative of the test compound's ability to modulate reverse cholesterol transport.

### BRIEF DESCRIPTION OF THE DRAWING

FIG. 1 provides a graph demonstrating the percent efflux to various acceptors from control and upregulated (treated with cis retinoic acid (RA)/22-OH) murine Kupffer cells.

FIGS. 2A and 2B provide a time course of liver (FIG. 2A) and plasma (FIG. 2B) cholesterol tracer after injection of ³H-particulate cholesterol as well as the percent of the ³H-cholesterol present as ester.

FIG. 3 is a graph of a fast protein liquid chromatography (FPLC) analysis of plasma cholesterol and radiolabel obtained two hours after injection with particulate cholesterol.

FIG. 4 provides a graph demonstrating the effect of time on the particulate cholesterol present in liver parenchymal cells (hepatocytes) and non-parenchymal cells (Kupffer cells).

FIG. 5 is a time course of plasma particulate cholesterol in DBA mice and ABCA1^{-/-} mice.

FIG. 6 is a graph depicting reduced accumulation of particulate cholesterol in feces of ABCA1^{-/-} mice as a measure of the final endpoint of reverse cholesterol transport.

FIG. 7 is a graph of the normalized activity of ³H-cholesterol in plasma from six humans at various timepoints from 0-420 minutes after administration. The activity of ³H-cholesterol was normalized to the activity at 20 minutes.

FIG. 8 is a graph of the normalized activity of ³H-cholesterol in plasma from six humans at various timepoints from 420 to 12,000 minutes after administration. The activity of ³H-cholesterol was normalized to the activity at 20 minutes.

FIG. 9 is a graph of the normalized activity of ³H-cholesterol in isolated HDL from six humans at various timepoints after administration. The activity of ³H-cholesterol was normalized to the activity at 20 minutes.

FIGS. 10A and 10B show the appearance of tracer ³H-cholesterol in plasma as free cholesterol and cholesteryl ester from two representative subjects at various timepoints from 0-420 minutes (FIG. 10A) or 0-10,000 minutes (FIG. 10B) after administration.

FIGS. 11A and 11B show the appearance of tracer ³H-cholesterol in isolated HDL as free cholesterol and cholesteryl ester from two representative subjects at various timepoints from 0-420 minutes (FIG. 11A) or 0-10,000 minutes (FIG. 11B) after administration.

FIG. 12 provides a multi-compartmental model to obtain various kinetic parameters involved in RCT.

### DETAILED DESCRIPTION OF THE INVENTION

In studies conducted in the early 1970s to investigate the mechanisms regulating cholesterol metabolism and its transfer from macrophages to blood, cholesterol preparations were administered to rats (Nilsson et al. (1972) J. Lipid Res., 13:32-38). The cholesterol preparations included a dilute suspension containing 10 μg/ml cholesterol, 0.9% NaCl, and 2.5% ethanol and a colloidal suspension containing 4% bovine serum albumin and a saturated cholesterol solution in ethanol and water. It was demonstrated that when a saturated solution of radio-labeled free cholesterol was mixed with albumin to stabilize the solution and then administered to rats as an intravenous bolus, the tracer rapidly disappeared from the blood compartment and then slowly reappeared (Nilsson et al. (1972) J. Lipid Res., 13:32-38). The disappearance from the blood compartment was due to the rapid uptake of the particulate cholesterol by reticuloendothelial cells (in particular liver Kuppfer cells and spleen macrophages) that subsequently released cholesterol back in the blood compartment. In several separate experiments radio-labeled cholesterol or its precursor (mevalonic acid) was administered in subjects with or without bile fistula (Schwartz et al. (1978) J. Clin. Invest., 61:408-423; Schwartz et al. (1982) J. Clin. Invest., 70:863-876; Schwartz et al. (2004) J. Lipid Res., 45:1594-1607). Tracer data obtained from plasma and bile were then analyzed using multi-compartmental analysis. Relevant to this protocol, it was found that the cholesterol-albumin complexes were cleared from the blood compartment very rapidly soon after intravenous administration and were subsequently effluxed back exclusively to circulating HDL as free cholesterol.

The instant invention demonstrates that microparticulate cholesterol is cleared from the blood compartment very rapidly soon after intravenous administration and is subsequently effluxed back to circulating HDL as free cholesterol. Herein, it is demonstrated that isolated Kupffer cells efflux cholesterol like other macrophages. Notably, Kupffer cells are not in direct contact with hepatic parenchymal cells. Therefore, cholesterol from Kupffer cells must efflux to an acceptor and enter the plasma compartment prior to subsequent metabolism and potential removal by hepatocytes. Accordingly, the administration of microparticulate cholesterol can be used to target labeled cholesterol specifically to macrophages in vivo. The subsequent reappearance of the labeled cholesterol in the plasma is a measure of macrophage cholesterol efflux in vivo. The methods of the instant invention allow for the specific labeling of macrophages with microparticulate cholesterol (e.g., radiolabeled). The methods of the instant invention also allow for the detection of net RCT in a single step by assaying for the cholesterol (e.g., radiolabeled) directly (e.g., specific activity) as opposed to using isotope dilution or by determining a ratio of label to free cholesterol.

Microparticulate or microcrystalline cholesterol can be formed, for example, by the introduction of a cholesterol ethanol solution into saline in the presence of serum albumin and vortexing. In a particular embodiment of the instant invention, the microparticulate cholesterol is contained with a composition. In yet another embodiment, the microparticulate cholesterol composition comprises cholesterol (microparticulate), ethanol, salt, and, optionally, serum albumin. In particular embodiments, the cholesterol is labeled. In another embodiment, cholesterol may be present in the microparticulate cholesterol composition at a concentration of about 1 μg/ml to about 50 μg/ml, more particularly about 5 μg/ml to about 30 μg/ml. For example, the cholesterol may be present at about 10 μg/ml. The serum albumin of the microparticulate cholesterol composition may be from any species (e.g., human) and may be present in the microparticulate cholesterol composition from 0% to about 15%, particularly from about 1% to about 5%. In one embodiment, the serum albumin is present at about 1%. The salt of the microparticulate cholesterol composition is preferably a physiological salt present at physiological ranges/concentrations (e.g., 0.9%). In a particular embodiment, the salt is KCl or NaCl, preferably NaCl. The ethanol of the microparticulate cholesterol composition may be present from about 0.25% to about 5.0%, more particularly about 0.5% to about 2.0%. In a particular embodiment, the ethanol is present at about 1%. The microparticulate cholesterol composition may further comprise at least one other pharmaceutically acceptable carrier, such as, for example, a preservative and/or an antibiotic.

In a particular embodiment of the instant invention, the microparticulate cholesterol composition may further comprise macrophage targeting agents. For example, the composition may further comprise negatively charged liposomes (e.g., liposomes comprising phosphatidylserine, phosphatidylinositol, phosphatidylglycerol, and/or phosphatidic acid) or liposomes containing other components involving lipid, protein, or carbohydrate constituents which would target macrophages through specific receptors or other biological uptake processes.

As stated hereinabove, the cholesterol of the instant invention is preferably labeled. The label allows for distinguishing the administered cholesterol from the cholesterol present in the host (endogenous cholesterol). In a particular embodiment, the cholesterol is isotopically labeled with at least one isotope. In a particular embodiment, the isotope is a radioactive isotope. Radioactive isotopes include, without limitation, ³H (tritium) and ¹⁴C. In another embodiment, the isotope is a stable isotope. Stable isotopes include, without limitation, ²H (deuterium), ¹¹C, ¹³C, ¹⁷O and ¹⁸O.

The instant invention provides compositions and methods for measuring reverse cholesterol transport in a mammal. Thus, the methods can be used as a diagnostic method for deficient reverse cholesterol transfer as well as associated disorders and diseases such as atherosclerosis. The methods generally comprise the steps of:

a) administering a composition comprising microparticulate cholesterol to a host;

b) obtaining at least one biological sample from the host; and

c) determining the amount of the cholesterol administered in step a) in the biological sample obtained in step b). The composition may be administered by injection (e.g., intravenous injection). The reappearance of the administered cholesterol correlates to the reverse cholesterol transport in the host. For example, the detection of a decreased amount of the administered cholesterol in the obtained biological sample compared to a control (e.g., the amount of the administered cholesterol in a biological sample obtained from a normal (healthy) host) indicates the host has a defective/deficient reverse cholesterol transport. A direct side-by-side comparison with a normal (healthy) sample need not be performed every time. Indeed, the results from an experimental sample from a host may be compared to at least one standard (e.g., a standard curve) obtained from normal (healthy) individuals and/or patients with defective reverse cholesterol transport, in order to determine whether the tested subject has normal or deficient reverse cholesterol transport. In a particular embodiment, the time of the administration of the composition comprising microparticulate cholesterol and the time of obtaining the biological sample(s) are the same for the test subject and the standards being compared.

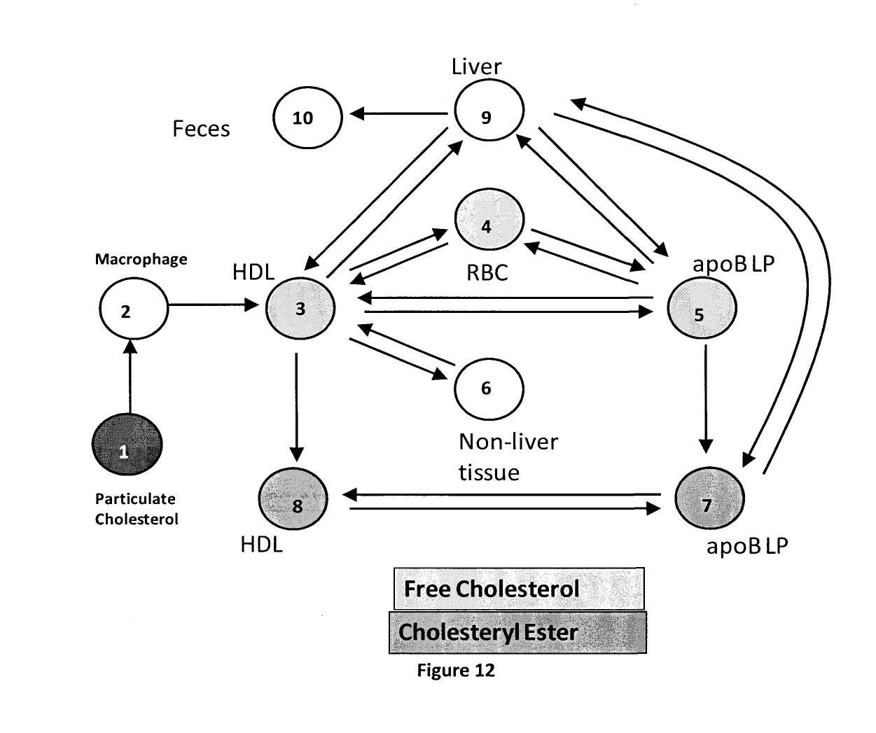

As explained herein, reverse cholesterol transport may be considered as having three phases: 1) efflux of cholesterol from macrophages and similar cells into interstitial fluid and plasma; 2) transport of effluxed cholesterol from the bloodstream to the liver; and 3) excretion of cholesterol from the liver into the bile and ultimately the feces. The methods of the instant invention may be used to measure any or all of these phases (FIG. 12). For example, the linear rate of reappearance of cholesterol allows for analysis of efflux from macrophages (the first step of RCT), the plateau and decline allows determination of the removal rate of cholesterol from plasma (intermediate steps of RCT), and the stool levels allow for the determination of excretion (final step of RCT). Further, the appearance of tracer in cholesteryl ester allows for the analysis of the conversion of free cholesterol into cholesteryl ester in blood. Individual kinetic parameters can be obtained by modeling the data obtained, for example, for compartments 1, 3, 4, 5, 7, 8, and 10 (FIG. 12).

While the methods and compositions of the instant invention are exemplified herein as using cholesterol, cholesterol precursors (e.g., mevalonic acid) or other sterols (e.g., sitosterol) may be used in place of the cholesterol or in combination with the cholesterol.

The biological sample obtained from the patient can be any biological tissue, cell(s), or fluid from the subject which comprises the administered cholesterol. Preferably, the biological sample is accessible from an individual through sampling by minimally invasive or non-invasive approaches (e.g., urine collection, feces collection, blood drawing, needle aspiration, and the like). Biological samples include, without limitation, serum, plasma, blood, urine, feces, skin tissue samples, and hair samples. In particular embodiments, the biological sample is feces or blood. If multiple samples are obtained, the samples may be obtained at regular or irregular intervals from the patient. In a particular embodiment, the sample(s) may obtained about 0.5 hour, about 1 hour, about 2 hours, about 4 hours, about 6 hours, about 8 hours, about 12 hours, and/or 1, 2, 3 or more days after administration of the microparticulate cholesterol. In another embodiment, at least one sample may be obtained at the time or before the microparticulate cholesterol composition is administered (e.g., as a baseline).

The amount of cholesterol present in the biological sample may be determined by any method. If the sterol is radiolabeled, then the sterol may be detected by scintillation counting. In a particular embodiment, the amount of administered radiolabeled cholesterol is measured by assaying the radiolabel signal directly. If the sterol is labeled with a stable isotope, the cholesterol may be isolated/purified from the biological sample. In a particular embodiment, the stable isotopically labeled sterol is measured by mass spectrometry.

In accordance with another aspect of the instant invention, the methods of measuring reverse cholesterol transfer described hereinabove are performed on a host to generate a first profile of the administered cholesterol in the biological sample obtained from the subject (i.e., a baseline of the reverse cholesterol transport is generated). The methods are repeated on the host wherein at least one test compound has been administered to the subject. The test compound may be administered before the administration of the microparticulate cholesterol. The repeated method leads to the production of a second profile of the reverse cholesterol transport based on the amount of administered cholesterol in the biological sample obtained from the subject. The first and second profiles can then be compared. The presence of a greater amount of the administered cholesterol in the biological sample obtained after the administration of the test compound indicates the test compound increases reverse cholesterol transport. A decrease in the amount of the administered cholesterol in the biological sample obtained after the administration of the test compound indicates the test compound decreases reverse cholesterol transport. If the first and second profiles are the same, then test compound has no effect on reverse cholesterol transport.

In yet another embodiment of the instant invention, the test compound screening methods comprise administering the test compound to the host and then determining reverse cholesterol transport by the methods of the instant invention, without having first performed the method prior to test compound administration. The reverse cholesterol transport determined after the administration of the test compound may be compared to at least one standard as described above in order to determine the effects of the test compound on reverse cholesterol transport.

The test compound administered to the subject can be any molecule including, but not limited to, small molecules, chemical compounds, amino acids, carbohydrates, fatty acids, peptides, polypeptides, proteins, antibodies, cytokines, hormones, sugars, lipids, nucleic acid molecules, and polynucleotides.

Test compounds determined to modulate (e.g., increase) reverse cholesterol transport by the above methods may be administered (e.g., in a pharmaceutically acceptable carrier) to a patient to treat diseases or disorders associated with defective reverse cholesterol transport such as atherosclerosis.

The methods of the instant invention are preferably performed on mammalian subjects, including humans. Mammals include, but are not limited to, primate, feline, canine, bovine, ovine, porcine, equine, rodent, lagomorph, and human subjects.

In accordance with another aspect of the instant invention, kits for the performance of the methods of the instant invention are provided. The kits may comprise at least one composition comprising the microparticulate cholesterol to be administered to the subject. The kit may further comprise one or more of the following components: instruction material, vials, tubes, means for obtaining a biological sample from a subject (e.g., needles), and mass spectrometry reagents (e.g., buffers).

### DEFINITIONS

The term “reverse cholesterol transport” refers to the net movement (e.g., efflux or transport) of extrahepatic cholesterol to the liver for elimination/excretion (e.g., into bile). The term “reverse cholesterol transport” may encompass the entire process by which cholesterol (including precursors, metabolites, and derivatives thereof) moves from macrophages into the bloodstream and from the bloodstream out of the body. In other words, the term “reverse cholesterol transport” may encompass the general process by which excess cholesterol is eventually removed from a living subject. Reverse cholesterol transport may be considered as having three phases: 1) efflux of cholesterol from macrophages and similar cells into interstitial fluid and plasma; 2) transport of effluxed cholesterol from the bloodstream to the liver; and 3) excretion of cholesterol from the liver into the bile and ultimately the feces.

“Pharmaceutically acceptable” indicates approval by a regulatory agency of the Federal government or a state government. “Pharmaceutically acceptable” agents may be listed in the U.S. Pharmacopeia or other generally recognized pharmacopeia for use in animals, and more particularly in humans.

A “carrier” refers to, for example, a diluent, adjuvant, preservative (e.g., Thimersol, benzyl alcohol), anti-oxidant (e.g., ascorbic acid, sodium metabisulfite), solubilizer (e.g., Tween 80, Polysorbate 80), emulsifier, buffer (e.g., Tris HCl, acetate, phosphate), antimicrobial, bulking substance (e.g., lactose, mannitol), excipient, auxillary agent or vehicle with which an active agent of the present invention is administered. Pharmaceutically acceptable carriers can be sterile liquids, such as water and oils, including those of petroleum, animal, vegetable or synthetic origin. Water or aqueous saline solutions and aqueous dextrose and glycerol solutions are preferably employed as carriers, particularly for injectable solutions. Suitable pharmaceutical carriers are described in “Remington's Pharmaceutical Sciences” by E. W. Martin (Mack Publishing Co., Easton, Pa.); Gennaro, A. R., Remington: The Science and Practice of Pharmacy, 20th Edition, (Lippincott, Williams and Wilkins), 2000; Liberman, et al., Eds., Pharmaceutical Dosage Forms, Marcel Decker, New York, N.Y., 1980; and Kibbe, et al., Eds., Handbook of Pharmaceutical Excipients (3^{rd} Ed.), American Pharmaceutical Association, Washington, 1999.

The term “isolated” is not meant to exclude artificial or synthetic mixtures with other compounds or materials, or the presence of impurities that do not interfere with the desired activity, and that may be present, for example, due to incomplete purification, or the addition of stabilizers.

As used herein, the term “microparticulate” refers to solid matter comprising particles. Microparticulate particles may be less than about 100 μm in diameter. The term may be used interchangeably with the term “microcrystalline.”

As used herein, the term “stable isotope” refers to isotopes of an element that are not radioactive.

The following examples are provided to illustrate various embodiments of the present invention. They are not intended to limit the invention in any way.

### Example 1

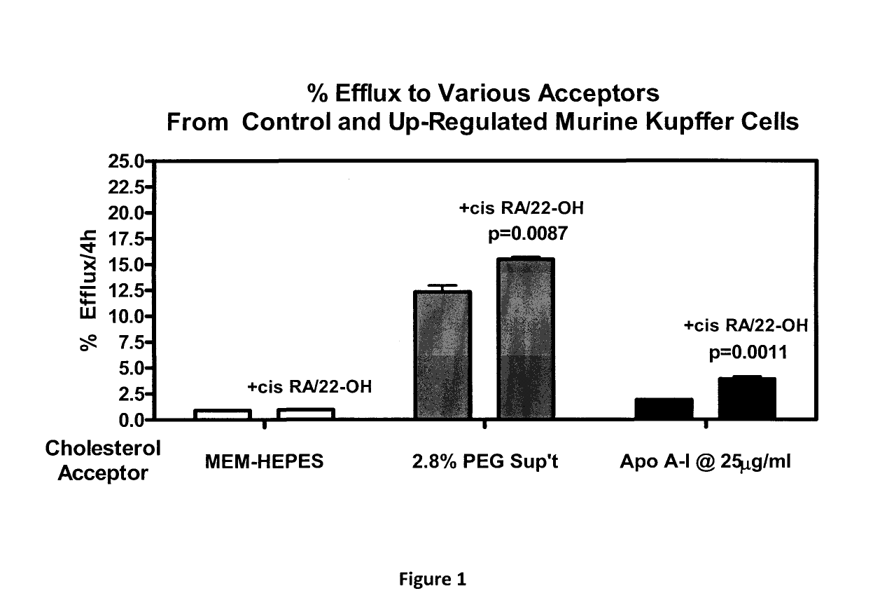

Primary murine Kupffer cells were isolated and experiments were performed to confirm that they efflux cholesterol like other macrophages. Kupffer cells are known to express the transporters involved in cellular efflux of cholesterol, namely ABCA1, ABCG1, and scavenger receptor class B type 1 (SRB1). FIG. 1 demonstrates that Kupffer cells efflux cholesterol to both mature high density lipoprotein as well as lipid-free apoA-I and that both pathways are increased by liver X receptor (LXR) agonism with cis retinoic acid (RA)/22-OH.

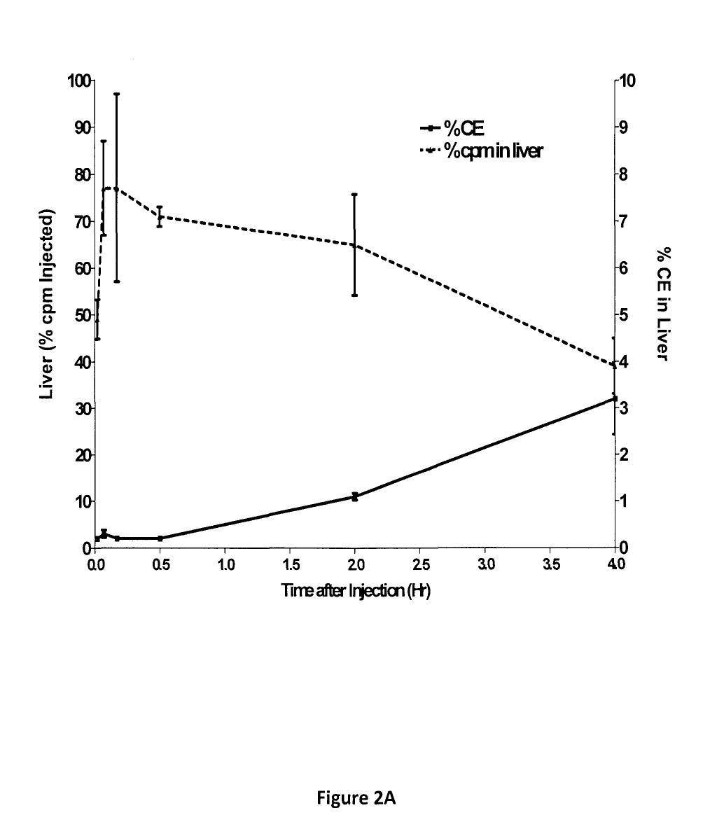

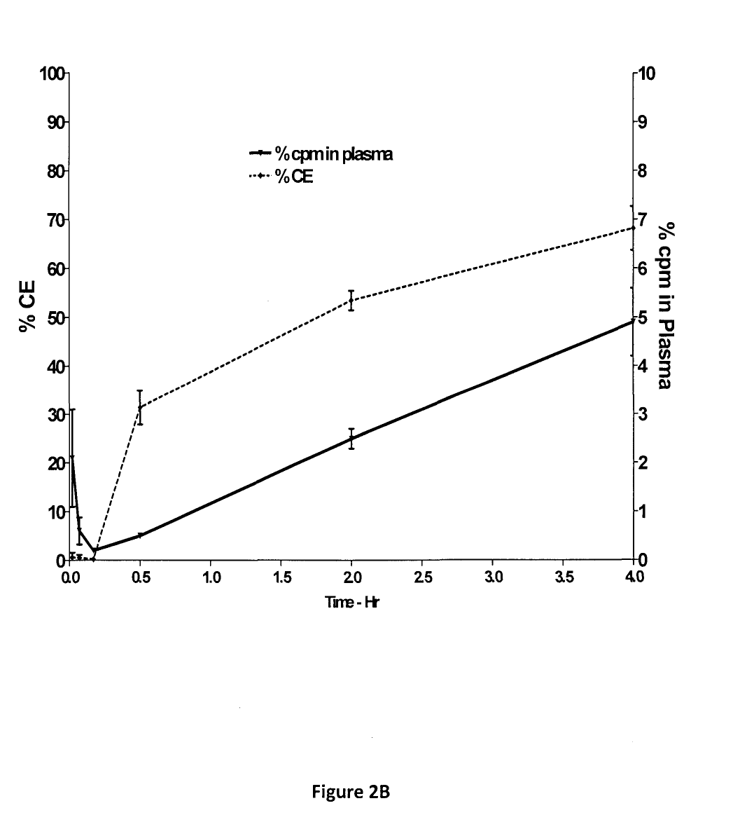

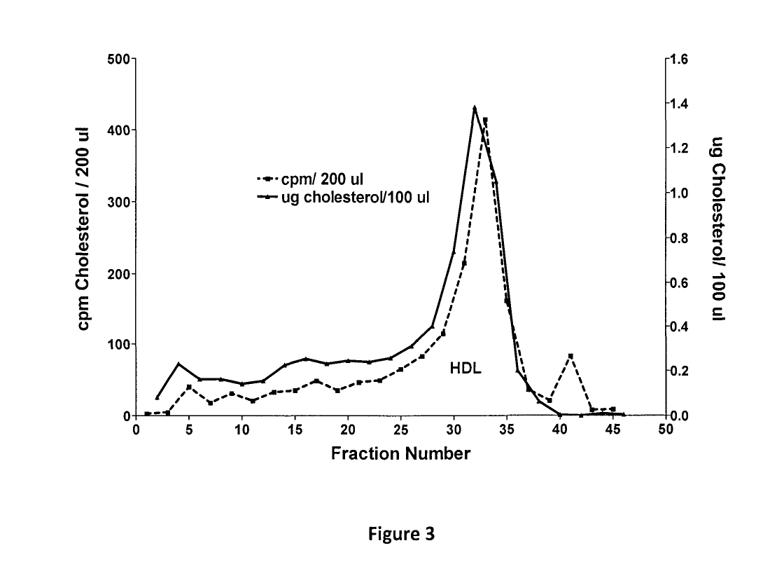

Initial experiments were subsequently performed in mice to test the use of microparticulate cholesterol to measure reverse cholesterol transport. Microparticulate cholesterol was formed by the introduction of a cholesterol ethanol solution into saline in the presence of serum albumin and vortexing. Upon injection of a saline solution of microparticulate radiolabeled cholesterol, it was determined that greater than 99% of the tracer was removed from the blood in the first 10 minutes with extremely low counts in plasma. In studies where mice were harvested at 10 minutes after administration, it was determined that approximately 75% of the injected dose was in the liver and an additional 5% in spleen. In mice followed over a four hour period, the amount of tracer present in the liver decreased to 40% (FIGS. 2A and 2B). Correspondingly, there was a reappearance of plasma tracer reaching 5% of injected dose at 4 hours consistent with initiation of efflux pathways from the macrophages. After 48 hours, the % counts per minute (cpm) in liver had decreased to 5.2+/−1.5 and that in plasma to 2.0+/−0.5. Furthermore, the vast majority of the ³H-cholesterol tracer at two hours was found in mature HDL while a small peak is found in the lipid-poor HDL fraction (FIG. 3).

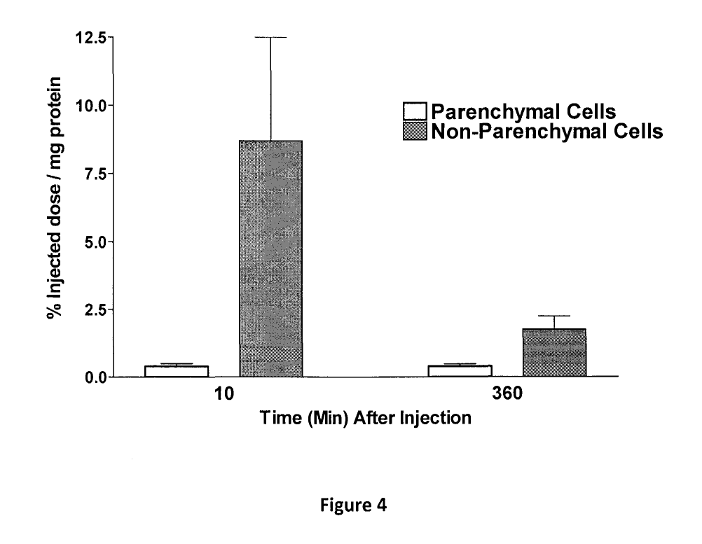

Parenchymal and Kupffer cells were also isolated from mice injected with particulate cholesterol. At 10 minutes, the majority of the counts per minute are in Kupffer cell (FIG. 4). At 6 hours, the ratio of cpm in Kupffer cells versus parenchymal cells is greatly reduced (FIG. 4).

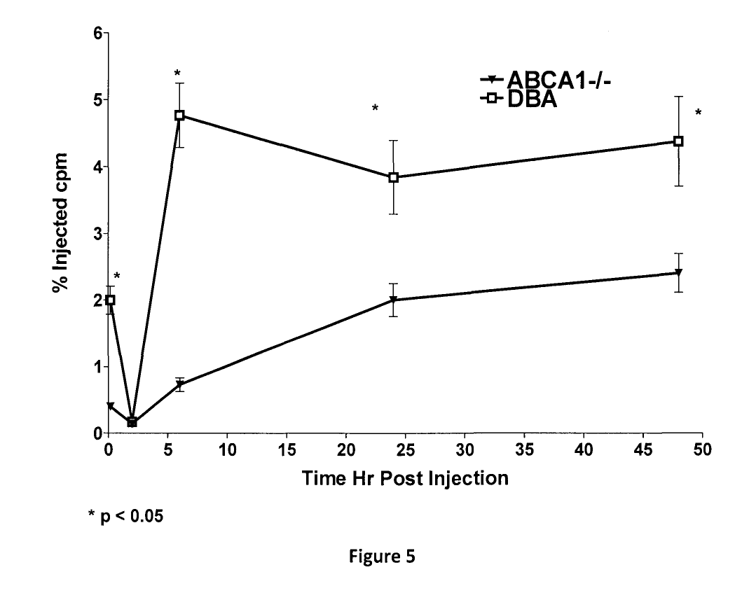

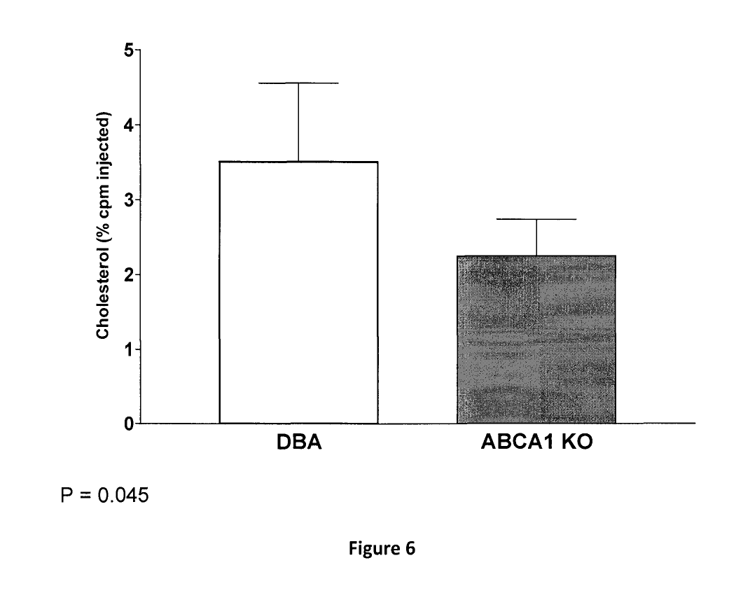

Experiments were also performed to demonstrate the use of microcrystalline cholesterol injection for measuring RCT. Specifically, ABCA1 KO mice were compared to wild-type mice after microcrystalline cholesterol administration under the hypothesis that the ABCA1 KO mice would exhibit a slower appearance of the ³H-cholesterol in plasma and a reduced excretion of tracer cholesterol in feces over 48 hours. FIGS. 5 and 6 demonstrate that these results were, in fact obtained, consistent with the impaired macrophage RCT in ABCA1 KO mice. ABCA1 knockout mice demonstrate an approximate 30% decrease (P=0.045) in labeled in feces compared with the wild-type controls, which is consistent with a known deficit in RCT levels in ABCA1 knockout mice.

### Example 2

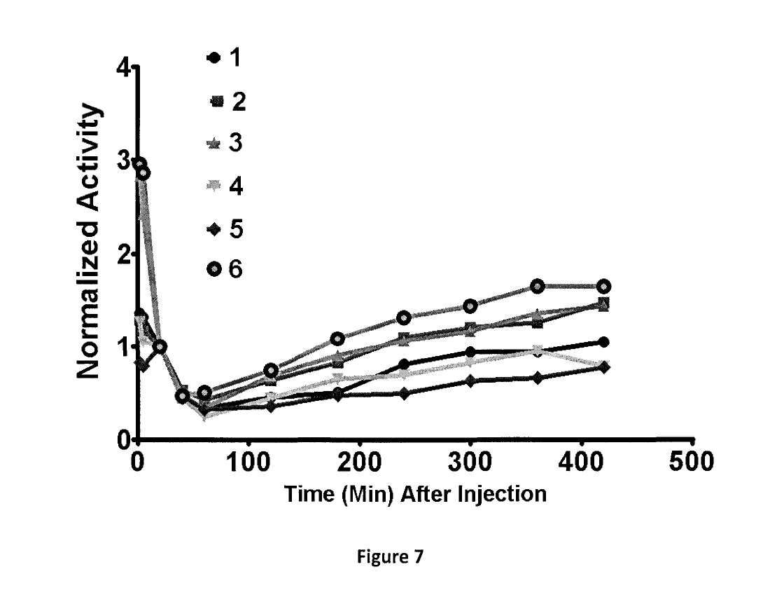

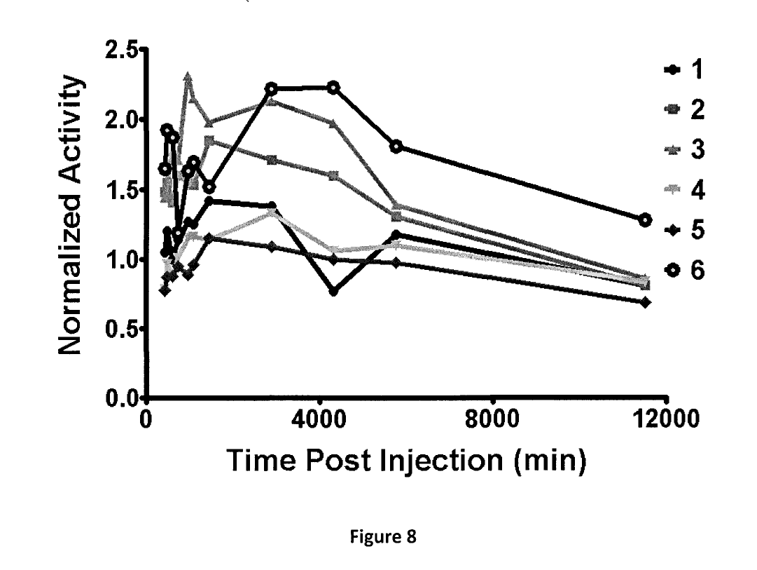

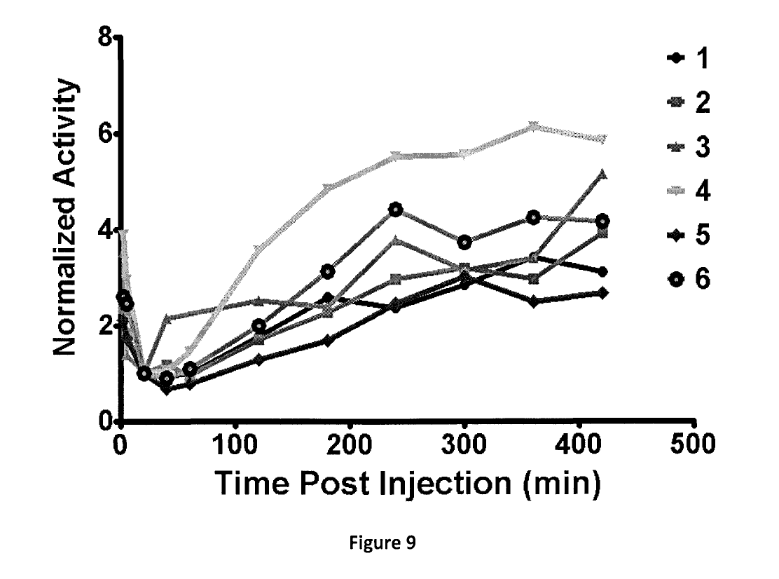

A study was conducted where normal human subjects (n=6) were injected with tritium labeled cholesterol particulate and plasma and feces were collected over several days. Greater than 95% of the cholesterol was removed within the first 40 minutes after injection (FIG. 7). Subsequently, the tracer reappeared in the plasma at a linear rate for the approximately the next 300 minutes (FIG. 7). The tracer then reached a plateau and subsequently declined (FIG. 8). A similar initial pattern was observed in isolated HDL (FIG. 9). Finally, a 4 day stool collection contained about 1000 cpm/g of feces. The linear rate of reappearance of ³H-cholesterol allows for analysis of efflux from macrophages (the first step of RCT), the plateau and decline allows estimation of the removal rate of cholesterol from plasma (intermediate steps of RCT), and the stool ³H-sterol allows estimation of fecal excretion (final step of RCT). This in vivo human data is consistent with the preclinical data and indicate that total RCT, the overall ability to excrete cholesterol originating in the macrophage, can be determined in humans.

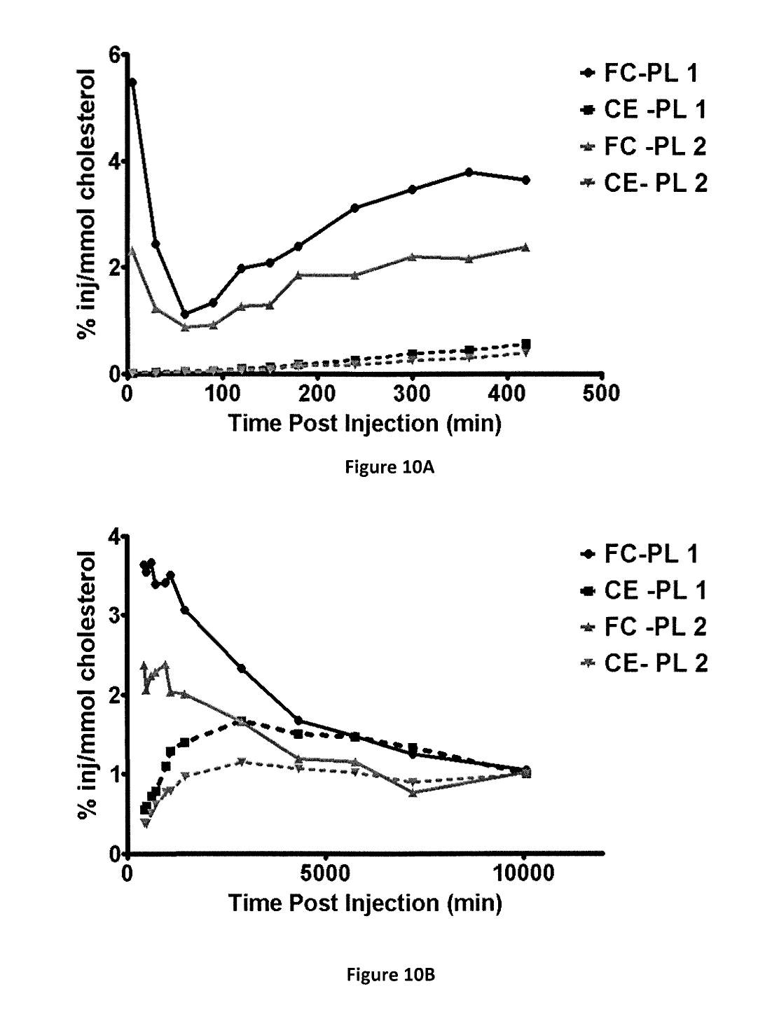

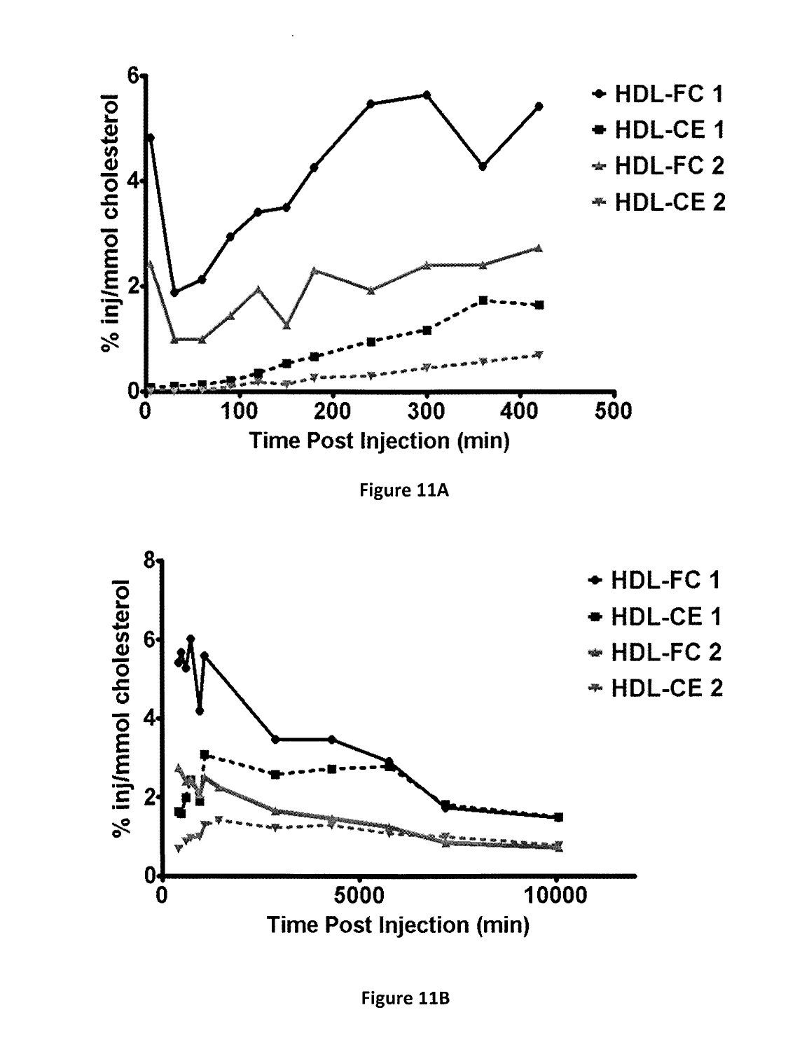

Studies were conducted where normal human subjects were injected with tritium labeled cholesterol particulate and plasma was collected over several days. A total of 52 subjects were enrolled for a total of 80 particulate cholesterol injections. No serious adverse events were reported. Greater than 95% of the cholesterol was removed within the first 40 minutes after injection. Subsequently the tracer reappeared in the plasma as free cholesterol at a linear rate for approximately the next 300 minutes (FIG. 10A) and as cholesteryl ester for an extended period (FIGS. 10A and 10B). Cholesterol and cholesteryl ester were separated by standard techniques. Notably, there is no cholesteryl ester at timepoint zero. FIGS. 11A and 11B show the appearance of tracer in HDL. As above, free cholesterol appears first and subsequently as cholesteryl ester over an extended period of time.

While certain of the preferred embodiments of the present invention have been described and specifically exemplified above, it is not intended that the invention be limited to such embodiments. Various modifications may be made thereto without departing from the scope and spirit of the present invention, as set forth in the following claims.

What is claimed is:

1. A method for measuring reverse cholesterol transport in a subject, said method comprising:
a) administering at least one composition comprising microparticulate cholesterol;
b) obtaining at least one biological sample from said subject; and
c) determining the amount of the cholesterol administered in step a) in said biological sample obtained in step b),
wherein a modulation in the amount of the cholesterol determined in step c) compared to the amount of cholesterol in a biological sample from a normal subject indicates modulated reverse cholesterol transport in said subject.

2. The method of claim 1, wherein said microparticulate cholesterol is isotopically labeled.

3. The method of claim 2, wherein microparticulate cholesterol is labeled with at least one radioactive isotope.

4. The method of claim 2, wherein microparticulate cholesterol is labeled with at least one stable isotope.

5. The method of claim 1, wherein said biological sample is blood.

6. The method of claim 1, wherein said subject is a human.

7. The method of claim 3, wherein step c) comprises determining the specific activity of the biological sample.

8. The method of claim 1, wherein step c) comprises mass spectrometry.

9. The method of claim 1, wherein said composition of step a) comprises microparticulate cholesterol, serum albumin, salt, and ethanol.

10. The method of claim 1, wherein step c) comprises determining the rate of reappearance of cholesterol in plasma, wherein a decrease in the reappearance of the cholesterol determined in step c) compared to a normal subject indicates decreased efflux from macrophages in the reverse cholesterol transport in said subject.

11. A method for determining the ability of a test compound to modulate reverse cholesterol transport in a mammal, said method comprising:
a) performing the method of claim 1, thereby generating a first profile of the administered cholesterol for said mammal;
b) administering said test compound to said mammal;
c) repeating the method of claim 1, thereby generating a second profile of the administered cholesterol for said mammal in the presence of said test compound,
wherein an increase in the administered cholesterol in the obtained biological sample in the second profile as compared to the first profile indicates that the test compound increases reverse cholesterol transport, and a decrease in the administered cholesterol in the obtained biological sample in the second profile as compared to the first profile indicates that the test compound decreases reverse cholesterol transport.
